(19) United States
(12) Patent Application Publication
(10) Pub. No.: US 2003/0025394 A1
(43) Pub. Date: Feb. 6, 2003

(54) Latch arrangement

(76) Inventor: Lorenz Lutz, Ingolstadt (DE)

Correspondence Address: CARLSON, GASKEY & OLDS, P.C., 400 WEST MAPLE ROAD, SUITE 350, BIRMINGHAM, MI, 48009, US

(21) Appl. No.: 10/199,952

(22) Filed: Jul. 19, 2002

(30) Foreign Application Priority Data
Aug. 1, 2001 (GB) 0118685.7

(51) Int. Cl. E05C 1/06

(52) U.S. Cl. 307/10.1; 292/144

(57) ABSTRACT

A latch arrangement including an electric motor operable to open a latch and at least one switch that is closeable by operation of an associated manually operable element. The switch is connected in series with the motor so that a release current passing through both the first switch and the motor can release the latch. The switch ensures that electrical disturbances in the motor do not inadvertently release the latch.

### CROSS REFERENCE TO RELATED APPLICATIONS

This application claims priority to United Kingdom (GB) Patent Application Number 0118685.7 filed on Aug. 1, 2001.

### BACKGROUND OF THE INVENTION

The present invention relates to a latch arrangement, and more particularly to a latch arrangement for a vehicle door.

Door latches are known wherein a latch bolt of the latch can releasably retain a striker, attached to fixed structure of a vehicle, in order to allow an associated door to open. Typically the latch bolt is retained in a closed or first safety position by a pawl.

Known door latches further include an electric motor operable to move the pawl so as to enable the latch to be power released.

However a problem of such devices is that it is possible to inadvertently actuate the motor, either as a result of electrical malfunction or as a result of EMC disturbances, resulting in the door opening unexpectedly.

An object of the present invention is to provide an improved form of latch arrangement that prevents inadvertent release of the latch when the motor is actuated due to malfunctions or disturbances.

### SUMMARY OF THE INVENTION

Accordingly, one embodiment of the invention is directed to a latch arrangement comprising a motor that releases a latch, a switch connected in series with the motor and a manually operable element that can close the switch. The motor releases the latch if the switch forms a circuit that allows a release current to pass through the switch and the motor. By requiring the release current to travel through both the motor and the switch before releasing the latch, the invention prevents inadvertent release of the latch. The switch acts as a safeguard to ensure that the latch release is truly due to manual operation of the operable element.

Other embodiments of the inventive system include circuits that have more than one switch.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 is a schematic view of a latch arrangement according to the present invention.

FIG. 2 is a schematic view of a further latch arrangement according to the present invention.

### DETAILED DESCRIPTION OF THE PREFERRED EMBODIMENTS

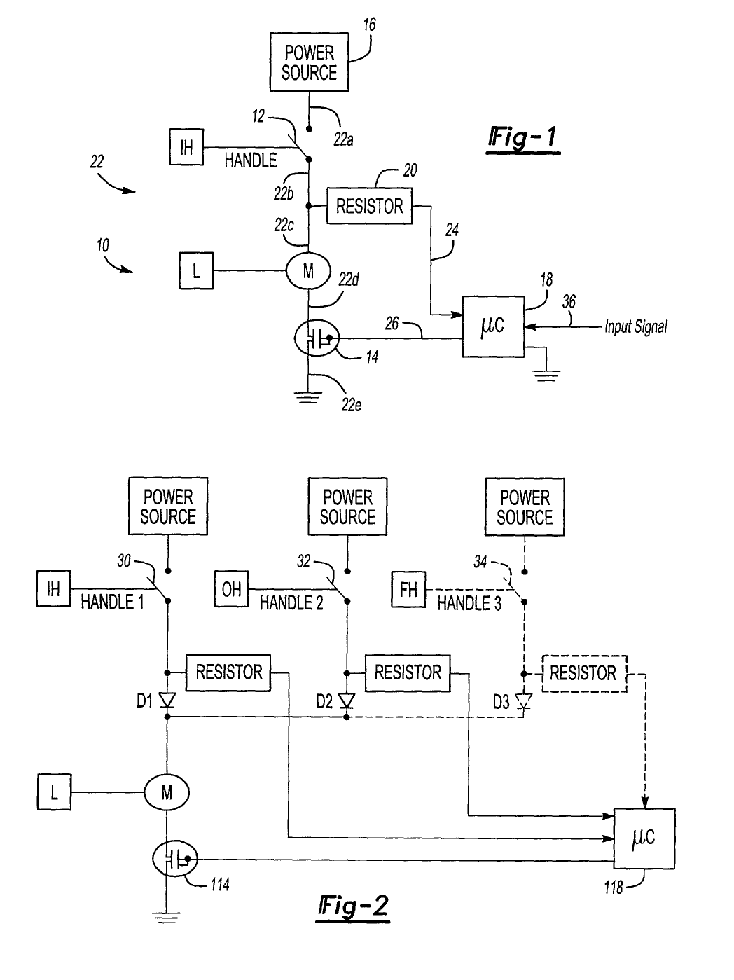

With reference to FIG. 1, there is shown a latch arrangement 10 including a latch power releasable by a motor M. The latch arrangement further includes a handle switch 12 (also known as a first switch) closeable by operation of an associated inside handle IH. The latch arrangement further includes a second switch 14 which typically might be a relay or a semiconductor device. A power source 16 is provided and it can be seen that the motor M, handle switch 12 and second switch 14 are all provided in series.

A control device in the form of a microprocessor 18 controls operation of the second switch 14 and is connected via a resistor 20 to a power cable 22B.

A power cable 22 comprises portions 22A, 22B, 22C, 22D and 22E, which connect the various components.

Microprocessor 18 is capable of receiving input signals 36 which define the state of the latch. Thus the latch can be unlocked, locked (wherein operation of an outside handle does not open a latch but operation of an inside handle does open a latch), superlocked (wherein operation of an outside or inside handle does not open the latch), or child safety (wherein in the “child safety on” condition, operation of an inside handle does not open a latch, but the latch may or may not be opened from an outside handle depending upon whether the latch is unlocked or locked).

The microprocessor is connected at the junction of power cable 22C and 22B via signal cable 24, and is also connected to second switch 14 by signal cable 26. It should be noted that the current required for the motor to operate latch L is typically 8-10 amps with a peak current of typically 16 amps. This should be contrasted with the currents traveling through signal cables 24 and 26 which typically would be fractions of an amp.

Operation of the latch arrangement is as follows.

Resistor 20 is used to connect the handle switch 12 to an input of the microprocessor 18, to enable the microprocessor to read the status of the handle switch 12. In the event that handle switch 12 is closed, then the microprocessor then signals second switch 14 to either remain open or to close depending upon the status of the latch 10.

Thus, consider the case where input signals 36 to the microprocessor 18 have indicated that the latch 10 is in an unlocked condition. With the inside handle in its rest position, both handle switch 12 and second switch 14 are in an open condition.

When it is required to open the latch, the inside handle IH is operated which in turn closes the handle switch 12. The microprocessor 18 can determine (from signals via signal line 24) that the first switch 12 is closed. Since an earlier signal 36 to the microprocessor has indicated that the latch is in an unlocked condition, the microprocessor 18 then signals for second switch 14 to close.

This results in a release current (typically 8-10 amps with a peak of typically 16 amps) passing through first handle switch 12, motor M and second switch 14, since these components are in series. In particular it should be noted that first switch 12 and second switch 14 should be designed to withstand such high current loads.

It can be seen that should the microprocessor suffer any EMC disturbance causing second switch 14 to inadvertently close, the motor will not cause the latch to release since the handle switch 12 is still open, preventing the formation of a complete circuit.

With reference to FIG. 2 there is shown a further embodiment of the present invention which in this case includes an inside handle switch 30 closeable by inside handle IH, an outside handle switch 32 closeable by outside handle OH, and an additional switch 34 closeable by an additional handle FH.

In this case each handle switch has an associated diode D1, D2 and D3 positioned such that the microprocessor can read the individual status of each handle switch.

Thus with the latch in a locked condition, operation of the outside handle will cause the outside handle switch 32 to close, but the microprocessor 118 will not close the second switch 114, preventing the latch from unlocking. However, operation of an inside handle will cause the inside switch 30 to close; in this case, the microprocessor 118 does close the second switch 114, thus allowing the door to open.

It should be understood that various alternatives to the embodiments of the invention described herein may be employed in practicing the invention. It is intended that the following claims define the scope of the invention and that the method and apparatus within the scope of these claims and their equivalents be covered thereby.

We claim:

1. A latch arrangement comprising:
a motor operable to release a latch;
a first switch connected to the motor; and
a manually operable element, wherein the first switch is closable by the manually operable element,
wherein the motor releases the latch if the first switch forms a circuit that allows a release current to pass through the first switch and the motor.

2. The latch arrangement of claim 1, wherein the manually operable element is a door handle.

3. The latch arrangement of claim 1, further comprising:
a second switch connected to the motor and the first switch; and
a control device coupled to the second switch, wherein the second switch closes in response to a control signal from the control device and wherein the motor releases the latch if the first switch and the second switch form a circuit that allows the release current to pass through the first switch, the second switch and the motor.

4. The latch arrangement of claim 3, wherein the first switch is closable by an inside door handle and the second switch is closable by an outside door handle.

5. The latch arrangement of claim 3, wherein the second switch is a relay.

6. The latch arrangement of claim 3, wherein the second switch is a semiconductor device.

7. The latch arrangement of claim 3, wherein the control device is a microprocessor.

8. The latch arrangement of claim 3, wherein the control device is an integrated control unit (ICU).

9. The latch arrangement of claim 3, wherein the control device sends the control signal to the second switch responsive to at least one signal from the group consisting of an unlock signal, a lock signal, a superlock signal and a child safety signal.

10. The latch arrangement of claim 3, wherein the control device controls the duration of closure of the second switch.

11. The latch arrangement of claim 3, further comprising:
a third switch connected to the motor; and
a second control device coupled to the third switch, wherein the third switch closes in response to a second control signal from the second control device and wherein the motor releases the latch if the third switch forms a circuit that allows the release current to pass through the third switch and the motor.

12. The latch arrangement of claim 11, wherein the first switch is closable by an inside door handle, the second switch is closable by an outside door handle, and the third switch is closable by a further door handle.
